(19) United States
(12) Patent Application Publication
(10) Pub. No.: US 2011/0179185 A1
(43) Pub. Date: Jul. 21, 2011

(54) System and Method for Adaptive Differentiated Streaming

(75) Inventors: Ye-Kui Wang, Bridgewater, NJ (US); Yue Chen, San Jose, CA (US); Sanqi Li, Plano, TX (US); Hongbing Li, Belle Mead, NJ (US); Hong Heather Yu, West Windsor, NJ (US)

(73) Assignee: FutureWei Technologies, Inc., Plano, TX (US)

(21) Appl. No.: 13/009,771

(22) Filed: Jan. 19, 2011

Related U.S. Application Data
(60) Provisional application No. 61/296,790, filed on Jan. 20, 2010.

(51) Int. Cl. G06F 15/16

(52) U.S. Cl. 709/231

(57) ABSTRACT

A system and method for adaptive differentiated streaming are provided. A method for server operations includes establishing a connection for streaming media to a subscriber, receiving a request for a selected media content alternative, and streaming the selected media content alternative to the subscriber. The media content alternative to be streamed is selected based on a classification of the subscriber.

This application claims the benefit of U.S. Provisional Application No. 61/296,790, filed Jan. 20, 2010, entitled “Differentiated and VIP Services in Adaptive Streaming,” which application is hereby incorporated herein by reference.

### TECHNICAL FIELD

The present invention relates generally to digital communications, and more particularly to a system and method for adaptive differentiated streaming.

### BACKGROUND

In general, streaming (or content streaming) refers to a multimedia service wherein a subscriber (or subscribers) may receive (or simultaneously receive) and playback media content, such as music, images, video, multimedia, and so on. The media content may be sourced by a server to the subscriber(s) over a communications network.

Conventional streaming techniques make use of Real Time Transport Protocol/User Datagram Protocol/Internet Protocol (RTP/UDP/IP) to transport the media content data, encapsulated as RTP packets, and use Real Time Streaming Protocol (RTSP) for session control and Session Description Protocol (SDP) for session description.

Hypertext Transfer Protocol (HTTP) adaptive streaming refers to a streaming service wherein the HTTP protocol is used for the transport of content media data. In HTTP adaptive streaming, a protocol set of HTTP/Transmission Control Protocol/IP (HTTP/TCP/IP) may be used for transport of media data that is encapsulated as files or parts of files. HTTP may also be used for the control of the streaming processes and eXtensible Markup Language (XML) may typically be used for description of the content media data. The description of the content media data is typically referred to as Media Presentation Description (MPD) or simply a manifest.

HTTP adaptive streaming may not be capable of supporting differentiated services, which may be described as services differentiated based on a subscriber's subscription level. For example, some subscribers may be willing to pay more for a premium subscription in order to obtain a high quality of experience (QoE), which may provide them with a higher spatial resolution, bitrate and/or frame rate, and so on. Furthermore, their content may be advertisement free. Such subscribers may be referred to as VIP subscribers and their subscriptions may be referred to as VIP subscriptions. While, non-VIP subscribers (for example, free subscribers or lower-tier subscribers) may be satisfied with lower spatial resolution, bitrate, and/or frame rate, and so on.

Compared to RTSP/RTP based streaming, HTTP adaptive streaming may have the following advantages:
HTTP adaptive streaming has the ability to use standard servers and standard HTTP caches (or cheap servers in general) to deliver the content, so that it can be delivered from a Content Distribution Network (CDN) or any other standard server farm;
HTTP adaptive streaming has the ability to move control of “streaming session” entirely to the client, which basically only opens one or several TCP connections to one or several standard HTTP servers or caches;
HTTP adaptive streaming enables easy and effortless streaming services by avoiding Network Address Translation (NAT) and firewall traversal issues;
HTTP adaptive streaming enables start of the streaming process after transmitting fewer protocol messages; and
Application layer Forward Error Correction (FEC) may be needed in some RTSP/RTP based streaming systems but absolutely not required in HTTP adaptive stream, hence overhead caused by FEC may be reduced.

### SUMMARY OF THE INVENTION

These and other problems are generally solved or circumvented, and technical advantages are generally achieved, by example embodiments of the present invention which provide a system and method for adaptive differentiated streaming

In accordance with an example embodiment of the present invention, a method for server operations is provided. The method includes: establishing a connection for streaming media to a subscriber; receiving a request for a selected media content alternative; and streaming the selected media content alternative to the subscriber. The media content alternative to be streamed is selected based on a classification of the subscriber.

In accordance with another example embodiment of the present invention, a method for device operations is provided. The method includes: establishing a connection for streaming media with a server; sending a request for the media content alternative; receiving the media content alternative over the connection; and displaying the media content alternative. The media content alternative to be streamed is selected based on a classification of a subscriber.

In accordance with another example embodiment of the present invention, a communications device is provided that includes a transmitter; a receiver; an establishing unit coupled to the transmitter and to the receiver; and a display unit coupled to the receiver and to the establishing unit. The transmitter transmits information, and the receiver receives streaming media content. The establishing unit establishes a connection for streaming media between the communications device and a server, and the display unit displays the received streamed media content. The media content alternative to be streamed over the connection is selected based on a classification of the communications device.

In accordance with another example embodiment of the present invention, a communications server is provided that includes a transmitter; a receiver; and an establishing unit coupled to the transmitter and to the receiver. The transmitter transmits information, and the receiver receives streaming media content requests; and the establishing unit establishes a connection for streaming media between a communications device and the server. The media content alternative to be streamed is selected based on a classification of the communications device.

One advantage disclosed herein is that it is possible to provide differentiated service to different levels of subscribers, thereby providing tiered services.

A further advantage of exemplary embodiments is that different techniques for providing tiered services are provided. Thereby enabling a tailoring of overhead and maintenance control to meet server and/or subscriber capability.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example diagram of a communications system;

FIG. 2 illustrates an example diagram of a communications system configured to implement the streaming services provided according to example embodiments described herein;

FIG. 3a illustrates an example flow diagram of operations in displaying streamed media content in accordance with example embodiments described herein;

FIG. 3b illustrates an example flow diagram of operations in streaming media content in accordance with example embodiments described herein;

FIG. 4a illustrates an example diagram of a table of media content manifests in accordance with example embodiments described herein;

FIG. 4b illustrates an example flow diagram of subscriber operations in displaying streamed media content in accordance with example embodiments described herein;

FIG. 4c illustrates an example flow diagram of server operations in streaming media content in accordance with example embodiments described herein;

FIG. 5a illustrates an example diagram of a table of media content manifests in accordance with example embodiments described herein;

FIG. 5b illustrates an example flow diagram of subscriber operations in displaying streamed media content in accordance with example embodiments described herein;

FIG. 5c illustrates an example flow diagram of server operations in streaming media content in accordance with example embodiments described herein;

FIG. 6 is an alternate example illustration of a communications device in accordance with example embodiments described herein; and

FIG. 7 is an alternate example illustration of a communications device in accordance with example embodiments described herein.

### DETAILED DESCRIPTION OF ILLUSTRATIVE EMBODIMENTS

The making and using of the presently example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a communications network serving different subscriber classes. The invention may be applied to other wireline, wireless, and/or a combination thereof, communications networks.

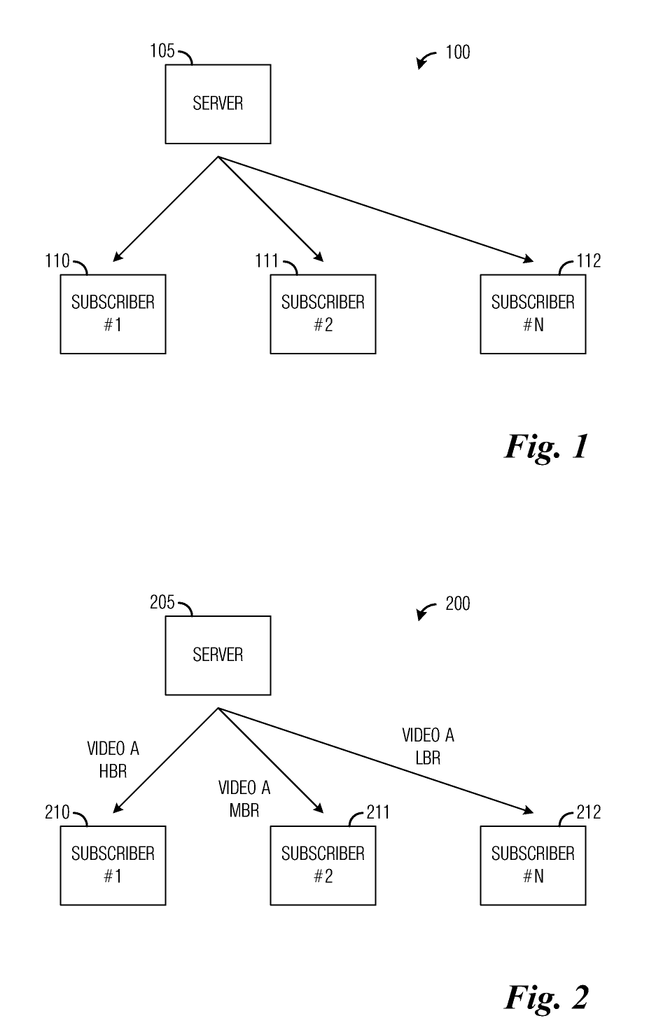

FIG. 1 illustrates a communications system 100. Communications system 100 includes a sever 105 and a number of subscribers, such as subscriber #1 110, subscriber #2 111, and subscriber #N 112. Server 105 may be a media content server capable of streaming media content to its subscribers. As shown in FIG. 1, server 105 is streaming media content to subscriber #1 110, subscriber #2 111, and subscriber #N 112. The media content being streamed to subscriber #1 110, subscriber #2 111, and subscriber #N 112 may be identical or different.

FIG. 2 illustrates a communications system 200 configured to implement the streaming services provided according to example embodiments described herein. Communications system 200 includes a sever 205 and a number of subscribers, such as subscriber #1 210, subscriber #2 211, and subscriber #N 212. Server 205 may be capable of streaming differentiated media content to different subscribers. As shown in FIG. 2, server 205 is streaming a single video (VIDEO A) to subscriber #1 210, subscriber #2 211, and subscriber #N 212. However, server 205 is streaming the video to subscriber #1 210 at a high bit rate (HBR), to subscriber #2 211 at a medium bit rate (MBR), and to subscriber #N 212 at a low bit rate (LBR).

As discussed previously, server 205 may serve subscribers differently depending on their subscription level. For example, some subscribers (VIP subscribers) desiring the highest QoE may elect to pay more for a premium subscription. The premium subscription may mean that the subscribers get to enjoy guaranteed spatial resolution, bitrate, and/or frame rate for their media content streams. Furthermore, the subscribers may have ad free media content streams. VIP subscribers may have a higher priority than regular subscribers (or subscribers of lower subscriptions). Of course, other differentiated services may be available to similarly situated subscribers; and therefore, the aforementioned services are not meant to be an exhaustive list. Furthermore, this list of services is not meant to limit or otherwise narrow the scope of the present invention unless otherwise specifically claimed.

It is also possible that there may be multiple classes of subscribers, e.g., first class, second class, third class, and so on, all the way down to free-of-charge subscribers, wherein first class subscribers receive services at the best QoE, second class subscribers receive services at a second best QoE, and so forth. Free-of-charge subscribers typically may receive services at a lowest QoE and with no guarantees. Note that the names that reference the varying types of service classes described herein are merely used to illustrate the varying degrees of subscribers and/or subscriptions available. Similarly, the number of services may vary depending on a myriad of factors. As such, any specific naming convention for subscribers and/or subscriptions, as well as the number of differing types of subscriptions, is used herein for illustrative purpose only and is not meant to limit or otherwise narrow the scope of the present invention unless otherwise explicitly claimed.

Although the discussion focuses on QoE, differentiation of services may also be governed by other parameters. For example, other parameters may include advanced service capability, additional content features, advertisement-free accessibility, access location limitations, etc. The first class subscribers may have the highest priority; the second class subscribers may have the second highest priority; and so on. Of course, other QoE differentiated services and the classification of such are contemplated herein; and thus, any specific QoE used herein and its association with a particular type of subscription class is used herein for illustrative purposes only, unless otherwise specifically claimed.

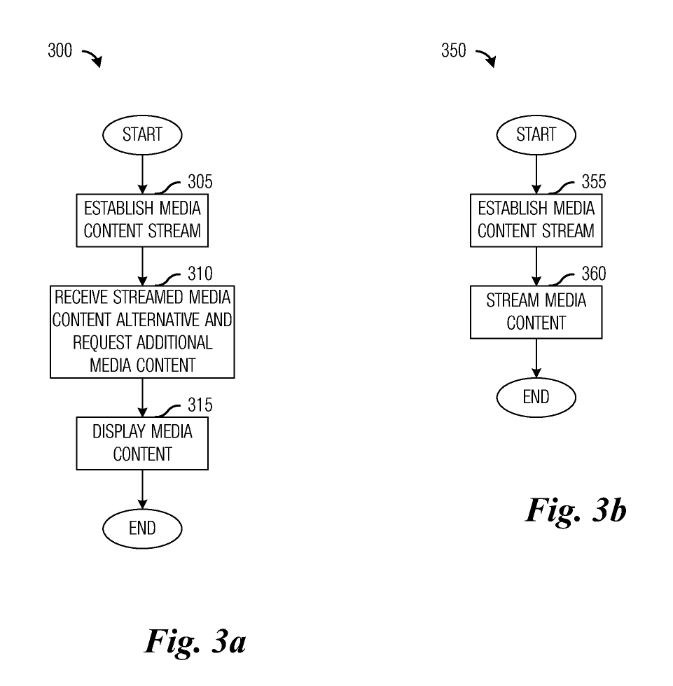

FIG. 3a illustrates a flow diagram of operations 300 in displaying streamed media content. Operations 300 may be indicative of operations occurring in a subscriber as the subscriber displays streamed media content. Operations 300 may occur while the subscriber is in a normal operating mode.

Operations 300 may begin with the subscriber establishing a media content stream (or connection) with a server (block 305). The connection may or may not be a persistent connection between the subscriber and the server. The subscriber may start to establish the media content stream with the server by sending a request to the server. Such a request may be an HTTP GET request containing the URL of the manifest for the media content, for example. Part of the establishment of the media content stream may be a setting of a variety of parameters of the media content stream, including spatial resolution, bitrate, frame rate, content extras, advertisement level, and so forth. The parameters may be based on the subscriber's subscription level, available communications system bandwidth, operation conditions, and so forth.

Part of establishing the media content stream may include the subscriber selecting a media content alternative (or media content alternative segment) from the manifest with the desired parameters and sending a request for the media content alternative (or media content alternative segment) to the server. According to an example embodiment, the subscriber may request a media content alternative by providing to the server information related to the media content alternative, such as a URL for the media content alternative, a file name of the media content alternative, or so forth.

The media content stream as described herein may be a logical stream. An actual path taken by a first single media content alternative segment may differ from an actual path taken by a second single media content alternative segment. Therefore, the discussion of a media content stream should not be construed as limiting the media to being streamed from server to subscriber over a single path.

After the media content stream is established, the subscriber may begin to receive the streamed media content alternate that it requested and the subscriber may request additional media content alternatives and/or segments (block 310) and the subscriber may begin to display the media content (block 315). According to an example embodiment, the subscriber may continue to request (and subsequently receive) media content. For example, the media content alternative selected by the subscriber may comprise multiple media content alternative segments, and the subscriber may send media requests for some or all of the media content alternative segments to the server. The subscriber may send the media requests for the media content alternative segments to the server all at the same time, sequentially, or a combination thereof. Displaying the media content may include playing music (or audio content), displaying pictures, playing video, or so on. Wherein after, operations 300 may then terminate.

Although the discussion focuses on the subscriber requesting a single media content alternative, in practice a media content alternative may actually be broken up into multiple media content alternative segments. Therefore, in order to receive the media content alternative in its entirety, the subscriber may need to request each of the media content alternative segments from the server. However, the embodiments described herein are operable with media content that is a single segment long or multiple segments long. Therefore, the discussion of single segment media content should not be construed as being limiting to either the scope or spirit of the embodiments.

FIG. 3b illustrates a flow diagram of operations 350 in streaming media content. Operations 350 may be indicative of operations occurring in a server as the server streams media content to a subscriber. Operations 350 may occur while the subscriber is in a normal operating mode.

Operations 350 may begin with the server establishing a media content stream with the subscriber (block 355). The server may establish the media content stream with the subscriber after receiving a request from the subscriber to establish the media content stream with the subscriber. Part of the establishment of the media content stream may be a setting of a variety of parameters of the media content stream, including spatial resolution, bitrate, frame rate, content extras, advertisement level, and so forth. The parameters may be based on the subscriber's subscription level, available communications system bandwidth, operation conditions, and so forth.

According to an example embodiment, establishment of the media content stream may include the subscriber selecting a media content alternative provided in a manifest provided by the server to the subscriber and sending a request for the media content alternative to the server. If the media content alternative is made up of multiple media content alternative segments, the sending of a request for a single media content alternative segment may be sufficient in the establishment of the media content stream.

After the media content stream is established, the server may begin to stream media content alternative to the subscriber (block 360). The server may continue to stream media content as long as it continues to receive requests for media content alternatives and/or media content alternative segments. Of course, example embodiments also contemplate a single request for streaming of content or a continuous request type delivery system as described herein; and thus, the actual type of request and delivery system is used herein for illustrative purposes unless otherwise specifically claimed. Wherein after, operations 350 may terminate.

According to an example embodiment, a manifest for media content appropriate to a subscriber's class or subscription level may be used during an establishment of a media content stream between a server and the subscriber.

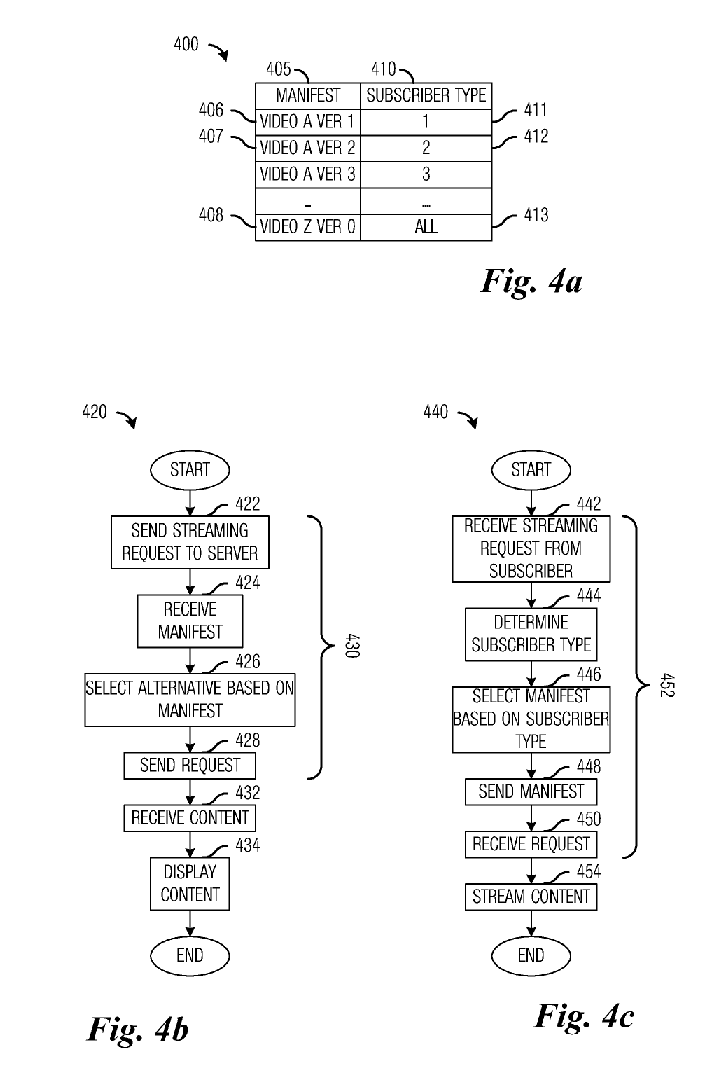

FIG. 4a illustrates a table 400 of media content manifests. Table 400 may be used by a server to store manifests for media content based on subscriber class and/or subscription type. Table 400 may be a look-up table stored in a memory and may be referenced by the server whenever the server is establishing a media content stream with a subscriber. The server may search table 400 based on media content and subscriber class and/or subscription level to determine a proper manifest to use in the establishment of the media content tunnel. Of course, other types of tables and data structures for storing, accessing, and/or verifying a subscriber class and/or subscription level (e.g., a hash table, etc.) are also contemplated herein.

Table 400 may include manifests 405 and client type 410 (which may include subscriber class and/or subscription type information). As an example, manifests 405 may include multiple manifests per media content. As shown in FIG. 4a, there are three manifests for “VIDEO A” with a first manifest 406 for subscriber type “1” 411, and a second manifest 407 for subscriber type “2” 412. As an example, first manifest 406 may include several media content alternatives for subscriber type “1” 411, which may be a VIP subscriber, while second manifest 407 may include fewer media content alternatives that first manifest 406 since subscriber type “2” 412 may be a lower subscriber type than subscriber type “1” 411. Similarly, for “VIDEO Z” there is a single manifest 408 for all subscriber types 413.

FIG. 4b illustrates a flow diagram of subscriber operations 420 in displaying streamed media content. Subscriber operations 420 may be indicative of operations occurring in a subscriber as the subscriber displays streamed media content. Subscriber operations 420 may occur while the subscriber is in a normal operating mode, or any other mode as set by the subscriber, subscription provider, or others as necessary.

Subscriber operations 420 may begin with the subscriber sending a request to a server requesting the server stream media content to the subscriber (block 422). According to an example embodiment, the request sent to the server may begin the establishment of a media content stream between the server and the subscriber.

The subscriber may then receive a manifest from the server (block 424). According to an example embodiment, the manifest provided by the server to the subscriber may be based on the subscriber's class and/or subscription type. For example, the manifest may include information regarding media parameters such as available spatial resolution, bitrate, and/or frame rate, extra content options, and so forth, all selected based on the subscriber's class and/or subscription type, and so on, in the form of different media content alternatives and/or media content alternative segments. For example, if the subscriber is a VIP subscriber, then the manifest provided by the server may include media content alternatives for all possible options for the media requested by the subscriber, while if the subscriber is a free subscription subscriber, then the manifest may include only media content alternative(s) for the lowest possible spatial resolution, bitrate, and/or frame rate, no extra content, and so on.

The subscriber may then select a media content alternative from the manifest (block 426). Although the subscriber may have a wide range of media content alternatives available to chose from, the subscriber may not automatically select the best available media content alternative due to factors such as a device being used to display the media (e.g., a computer, a high definition television, a smart phone, a personal digital assistant, and so forth), connection to the server (e.g., high bit rate, and so on), and so forth. In fact, other example embodiments contemplate automatically limiting the number of options presented to the subscriber based on such things as preferences, current system capabilities, preconfigured setting, or any other similar type of predetermined options.

After presentation and selection of the media content alternatives, the subscriber may then send a request for the selected media content alternative to the server (block 428). Collectively, blocks 422, 424, 426, and 428 may be referred to as establishing a media content stream 430.

After the media content stream has been established, the subscriber may begin to receive streamed media content (block 432) and begin to display the streamed media content (block 434). Subscriber may continue to request, receive, and display additional streamed media content. Wherein after, subscriber operations 420 may terminate.

FIG. 4c illustrates a flow diagram of server operations 440 in streaming media content. Server operations 440 may be indicative of operations occurring in a server as the server streams media content to a subscriber. Server operations 440 may occur while the subscriber is in a normal operating mode.

Server operations 440 may begin with the server receiving a request from a subscriber requesting that the server stream media content to the subscriber (block 442). According to an example embodiment, the request sent to the server may begin the establishment of a media content stream between the server and the subscriber.

The server may determine the subscriber's class and/or subscriber type (block 444). According to an example embodiment, the server may have access to subscriber information, from which the server may be able to determine the subscriber's class and/or subscription type. Based on the subscriber's class and/or subscription type, as well as a media content requested by the subscriber, subscriber preferences, device capabilities, and so on, the server may select a manifest from a manifest table (e.g., table 400) to provide to the subscriber (block 446). The manifest may contain one or more media content alternatives, which are dependent on the subscriber's class and/or subscription type.

According to an example embodiment, the server maintains the manifest table for each media content that it provides as well as for each class of subscriber and/or type of subscription that it supports.

The server may then send the manifest to the subscriber (block 448). The server may then receive request(s) from the subscriber, wherein the requests from the subscriber include parameters of the media (block 450). As an example, the manifest sent to the subscriber may indicate that the requested media is available at three different bitrates and specified as three different media content alternatives, the subscriber may choose one of the three bitrates and in its request for the media, specifying the chosen media content alternative. Collectively, blocks 442, 444, 446, 448, and 450 may be referred as establishing a media content stream 452.

The server may then begin to deliver (stream) the media content to the subscriber based on the request (block 454). The server may continue streaming the media content as long as it continues to receive requests from the subscriber. Wherein after, server operations 440 may terminate.

According to an example embodiment, a single manifest for media content independent of a subscriber's class or subscription level may be used during an establishment of a media content stream between a server and the subscriber.

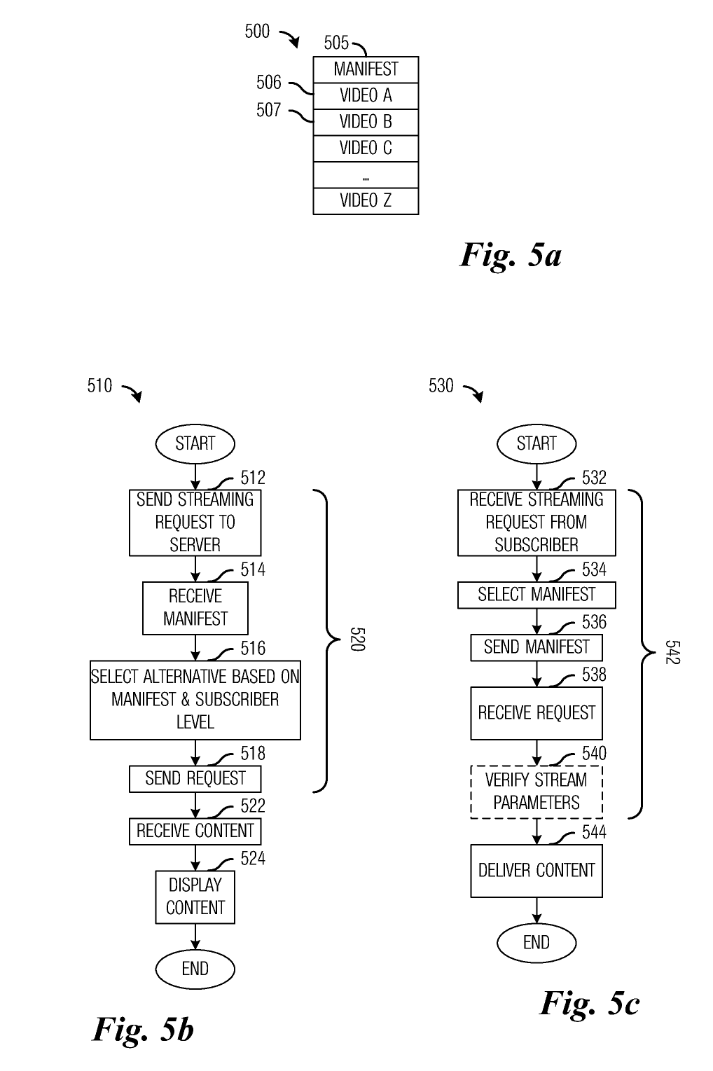

FIG. 5a illustrates a table 500 of media content manifests. Table 500 may be used by a server to store manifests for media content independent of subscriber class and/or subscription type, however, the manifests contain subscriber class and/or subscription type information. Table 500 may be a look-up table stored in a memory and may be referenced by the server whenever the server is establishing a media content stream with a subscriber. The server may search table 500 based on media content to determine a proper manifest to use in the establishment of the media content tunnel.

Table 500 may include manifests 505 which may include subscriber class and/or subscription type information. As an example, manifests 505 may include a single comprehensive manifest per media content. As shown in FIG. 5a, there is a single comprehensive manifest 506 for “VIDEO A” and a single comprehensive manifest 507 for “VIDEO B”, independent of subscriber class and/or subscription type. However, the single comprehensive manifest may contain all possible media content alternatives for the media content.

FIG. 5b illustrates a flow diagram of subscriber operations 510 in displaying streamed media content. Subscriber operations 510 may be indicative of operations occurring in a subscriber as the subscriber displays streamed media content. Subscriber operations 510 may occur while the subscriber is in a normal operating mode, or other forms of operating modes as previously noted.

Subscriber operations 510 may begin with the subscriber sending a request to a server requesting the server stream media content to the subscriber (block 512). According to an example embodiment, the request sent to the server may begin the establishment of a media content stream between the server and the subscriber.

The subscriber may then receive a manifest from the server (block 514). According to an example embodiment, the manifest provided by the server to the subscriber may be a comprehensive manifest for the media content requested by the subscriber (presented in the form of multiple media content alternatives) and is independent of subscriber's class and/or subscription type. For example, the manifest may include a list of multiple media content alternatives for the different media parameters such as available spatial resolution, bitrate, frame rate, extra content options, and so forth, for all subscriber classes and/or subscription types. The manifest may be organized based on different subscriber classes, subscription types, or other type of data structure for access purposes. As an example, each media parameter may include additional information regarding which subscriber classes and/or subscription type may select it and so on.

To avoid sending invalid requests (that will be denied by the server) by the subscriber, the manifest may include information indicative of which offered media parameters are accessible to what subscriber classes and/or subscription types. One embodiment for inclusion of such information may include adding a new attribute, named ServiceClass, for example, to an XML element Representation, which corresponds to an alternative of the content. The new attribute indicates which classes of subscribers are allowed to access the media content alternative corresponding to the Representation. For example, if the value associated with a media content alternative is equal to 1, then only class 1 subscribers can access the media content alternative, if the value is equal to 2, then only class 1 and class 2 subscribers can access the media content alternative, and so on. It is also possible to have the attribute as a string, and thus when there are two classes of differentiated subscribers, one class can be labeled “VIP” and the other “non-VIP”, for example.

The subscriber may then select a media content alternative from the manifest based on its own subscriber class and/or subscription type (block 516). According to an example embodiment, although the manifest contains media content alternatives for all subscriber classes and/or subscription types, the subscriber may only be able to select media content alternatives that are valid for its own subscriber class and/or subscription type. Collectively, blocks 512, 514, 516, and 518 may be referred to as establishing a media content stream 520.

After the media content stream has been established, the subscriber may begin to receive streamed media content (block 522) and begin to display the streamed media content (block 524). Subscriber may continue to request, receive, and display additional streamed media content. Subscriber operations 510 may then terminate.

FIG. 5c illustrates a flow diagram of server operations 530 in streaming media content. Server operations 530 may be indicative of operations occurring in a server as the server streams media content to a subscriber. Server operations 530 may occur while the subscriber is in a normal operating mode.

Server operations 530 may begin with the server receiving a request from a subscriber requesting that the server stream media content to the subscriber (block 532). According to an example embodiment, the request sent to the server may begin the establishment of a media content stream between the server and the subscriber.

The server may select a manifest from a manifest table (e.g., table 500) to provide to the subscriber (block 534). According to an example embodiment, the server may select the manifest based on the media content requested by subscriber. The server may then send the manifest to the subscriber (block 536). The server may then receive a request for media, wherein the request for media includes parameters selected by the subscriber from the manifest (block 538). Optionally, the server may verify the media parameters to determine if the subscriber is authorized to select the media parameters (block 540). Collectively, blocks 532, 534, 536, 538, and 540 may be referred as establishing a media content stream 542.

The server may then begin to deliver (stream) the media content to the subscriber based on the request (block 544). The server may continue streaming the media content as long as it continues to receive requests from the subscriber. Server operations 530 may then terminate.

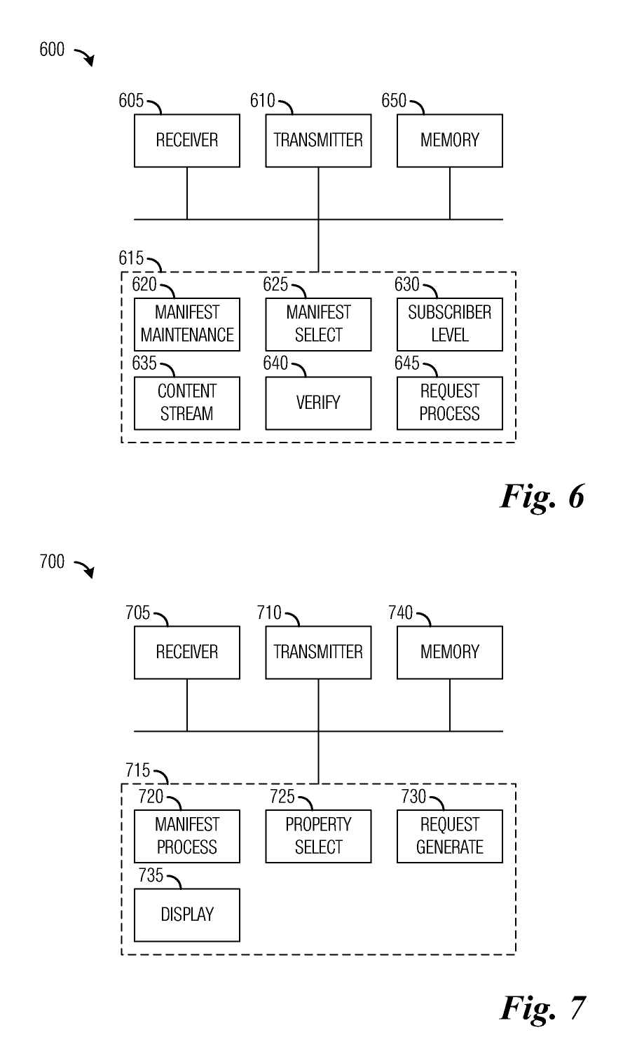

FIG. 6 provides an alternate illustration of a communications device 600. Communications device 600 may be used to implement various ones of the embodiments discussed herein. Communications device 600 may be used as a server.

As shown in FIG. 6, a receiver 605 is configured to receive information and a transmitter 610 is configured to transmit information. A manifest maintenance unit 620 is configured to generate and maintain manifests for different media content served by communications device 600. Furthermore, if communications device 600 maintains manifests for different subscriber classes and/or subscription types, manifest maintenance unit 620 is further configured to generate and maintain manifests for the different subscriber classes and/or subscription types. A manifest select unit 625 is configured to select a manifest based on media content requested by a subscriber (and potentially based on the subscriber's subscriber class and/or subscription type).

A subscriber level unit 630 is configured to determine a subscriber's class and/or subscription type. A content stream unit 635 is configured to stream media content to a subscriber based on the subscriber's request. A verify unit 640 is configured to verify media parameters selected by a subscriber, and a request process unit 645 is configured to process media content stream requests received by communications device 600. A memory 650 is configured to store a manifest table, information, and data.

The elements of communications device 600 may be implemented as specific hardware logic blocks. In an alternative, the elements of communications device 600 may be implemented as software executing in a processor, controller, application specific integrated circuit, or so on. In yet another alternative, the elements of communications device 600 may be implemented as a combination of software and/or hardware.

As an example, receiver 605 and transmitter 610 may be implemented as specific hardware blocks, while manifest maintenance unit 620, manifest select unit 625, subscriber level unit 630, content stream unit 635, verify unit 640, and/or request process unit 645 may be software modules executing in a processor 615 or custom compiled logic arrays of a field programmable logic array.

FIG. 7 provides an alternate illustration of a communications device 700. Communications device 700 may be used to implement various ones of the embodiments discussed herein. Communications device 700 may be used as a subscriber.

As shown in FIG. 7, a receiver 705 is configured to receive information and a transmitter 710 is configured to transmit information. A manifest process unit 720 is configured to process manifests received from servers. A property select unit 725 is configured to select media content alternatives from a manifest provided by a server. If the manifest includes media content alternatives for a variety of subscriber classes and/or subscription types, property select unit 725 may select the media content alternative that is valid selections for class and/or type of communications device 700, as well as its operating conditions (e.g., network load, network bandwidth, and so on).

Request generate unit 730 is configured to generate a media content stream request. As discussed previously, request generate unit 730 may continue to generate media content stream requests as long as a user of communications device 700 wishes to continue displaying media content. A display unit 735 is configured to display (e.g., play audio, display pictures and/or video, etc.) media content received by communications device 700. A memory 740 is configured to store a manifest table, information, and data.

The elements of communications device 700 may be implemented as specific hardware logic blocks. In an alternative, the elements of communications device 700 may be implemented as software executing in a processor, controller, application specific integrated circuit, or so on. In yet another alternative, the elements of communications device 700 may be implemented as a combination of software and/or hardware.

As an example, receiver 705 and transmitter 710 may be implemented as specific hardware blocks, while manifest process unit 720, property select unit 725, request generate unit 730, and/or display unit 735 may be software modules executing in a processor 715 or custom compiled logic arrays of a field programmable logic array.

The above described embodiments of communications devices 600 and 700 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 3a, 3b, 4b, 4c, 5b, and 5c—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for server operations, the method comprising:
establishing a connection for streaming media to a subscriber, wherein a media content alternative to be streamed is selected based on a classification of the subscriber;
receiving a request for a selected media content alternative; and
streaming the selected media content alternative to the subscriber.

2. The method of claim 1, wherein establishing a connection comprises:
receiving a connection request from the subscriber;
selecting a manifest for the media content, where the manifest comprises at least one media content alternative; and
transmitting the manifest to the subscriber.

3. The method of claim 2, wherein the manifest comprises media content alternatives of the media for all possible parameters and all possible classifications of the subscriber.

4. The method of claim 3, wherein the manifest further comprises an indication for each media content alternative, wherein an indication indicates which classification of the subscriber may select the media content alternative.

5. The method of claim 2, wherein receiving a request comprises verifying the request.

6. The method of claim 1, wherein establishing a connection comprises:
receiving a connection request from the subscriber;
selecting a manifest for the media content, where the manifest comprises at least one media content alternative, wherein the selecting is based on the classification of the subscriber; and
transmitting the manifest to the subscriber.

7. The method of claim 6, wherein the manifest comprises media content alternatives of the media for only the classification of the subscriber.

8. The method of claim 6, further comprising determining the classification of the subscriber.

9. A method for device operations, the method comprising:
establishing a connection for streaming media with a server, wherein a media content alternative to be streamed is selected based on a classification of a subscriber;
sending a request for the media content alternative;
receiving the media content alternative over the connection; and
displaying the media content alternative.

10. The method of claim 9, wherein establishing a connection comprises:
sending a connection request to a server;
receiving a manifest for the media, wherein the manifest comprises at least one media content alternative;
selecting the media content alternative from the manifest; and
transmitting a request for the selected media content alternative.

11. The method of claim 10, wherein selecting the media content alternative comprises selecting the media content alternative from the manifest.

12. The method of claim 9, wherein establishing a connection comprises:
sending a connection request to a server;
receiving a manifest for the media, wherein the manifest comprises at least one media content alternative;
selecting the media content alternative from the manifest based on the classification; and
transmitting a request for the selected media content alternative.

13. The method of claim 12, wherein the manifest comprises media content alternatives of the media for all possible classifications of the subscriber.

14. The method of claim 13, wherein the manifest further comprises an indication for each media content alternative, wherein each indication indicates which classification of the subscriber may select the media content alternative.

15. The method of claim 14, wherein selecting the media content alternative comprises selecting the media content alternative from a set of media content alternatives having an indication indicating the classification of the subscriber.

16. A communications device comprising:
a transmitter configured to transmit information;
a receiver configured to receive streaming media content;
an establishing unit coupled to the transmitter and to the receiver, the establishing unit configured to establish a connection for streaming media between the communications device and a server, wherein a media content alternative to be streamed over the connection is selected based on a classification of the communications device; and
a display unit coupled to the receiver and to the establishing unit, the display unit configured to display the received streamed media content.

17. The communications device of claim 16, wherein the establishing unit comprises:
a manifest process unit configured to process a manifest received from the server; and
a property select unit coupled to the manifest process unit, the property select unit configured to select the media content alternative for the media.

18. The communications device of claim 17, wherein the property select unit selects the media content alternative from media content alternatives contained in the manifest.

19. The communications device of claim 16, wherein the establishing unit comprises:
a manifest process unit configured to process a manifest received from the server; and
a property select unit coupled to the manifest process unit, the property select unit configured to select the media content alternative for the media based on a classification of the communications device.

20. The communications device of claim 19, wherein the manifest comprises media content alternatives of the media for all possible classifications of the communications device.

21. The communications device of claim 20, wherein the manifest further comprises an indication for each media content alternative, wherein each indication indicates which classification of communications device may select the media content alternative.

22. The communications device of claim 21, wherein the property select unit selects media content alternatives from a set of media content alternatives in the manifest having an indication indicating the classification of the communications device.

23. A communications server comprising:
a transmitter configured to transmit information;
a receiver configured to receive streaming media content requests; and
an establishing unit coupled to the transmitter and to the receiver, the establishing unit configured to establish a connection for streaming media between a communications device and the server, wherein a media content alternative to be streamed is selected based on a classification of the communications device.

24. The communications server of claim 23, wherein the establishing unit comprises a manifest select unit configured to select a manifest based on the media.

25. The communications server of claim 24, wherein the manifest comprises media content alternatives of the media for all possible classifications of the communications device.

26. The communications server of claim 25, wherein the manifest further comprises an indication for each media content alternative, wherein each indication indicates which classification of communications device may select the media content alternative.

27. The communications server of claim 24, wherein the establishing unit further comprises a verify unit configured to verify the media content alternative.

28. The communications server of claim 23, wherein the establishing unit comprises:
a subscriber level unit configured to determine a communication device's class and/or subscription type; and
a manifest select unit configured to select a manifest based on the media and the communication device's class and/or subscription type.

29. The communications server of claim 28, wherein the manifest comprises media content alternatives of the media for only the classification of the subscriber.
